(19) United States
(12) Patent Application Publication
(10) Pub. No.: US 2010/0154388 A1
(43) Pub. Date: Jun. 24, 2010

(54) PROCEDURE FOR REGENERATING A PARTICLE FILTER THAT IS ARRANGED IN THE EXHAUST GAS AREA OF A COMBUSTION ENGINE AND DEVICE FOR IMPLEMENTING THE PROCEDURE

(75) Inventors: Sascha Schumacher, Bietigheim-Bissingen (DE); Stephane De Tricaud, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/639,024

(22) Filed: Dec. 16, 2009

(30) Foreign Application Priority Data
Dec. 16, 2008 (DE) 10 2008 054 719.0

(51) Int. Cl. F02D 45/00; F01N 3/023

(52) U.S. Cl. 60/285; 60/295

(57) ABSTRACT

Suggested is a procedure for regenerating a particle filter (16) that is arranged in the exhaust gas area (15) of a combustion engine (10), whereby at least temporarily a throttling of the intake air (m_L) as well as a detection of the intake air pressure (p_L) is provided during the regeneration, and a device for implementing the procedure, at which the intake air pressure (p_L) is compared to a lower intake air pressure threshold value (p_L_Min) and when falling below the intake air pressure threshold value (p_L_Min) the throttling of the intake air (m_L) is reduced.

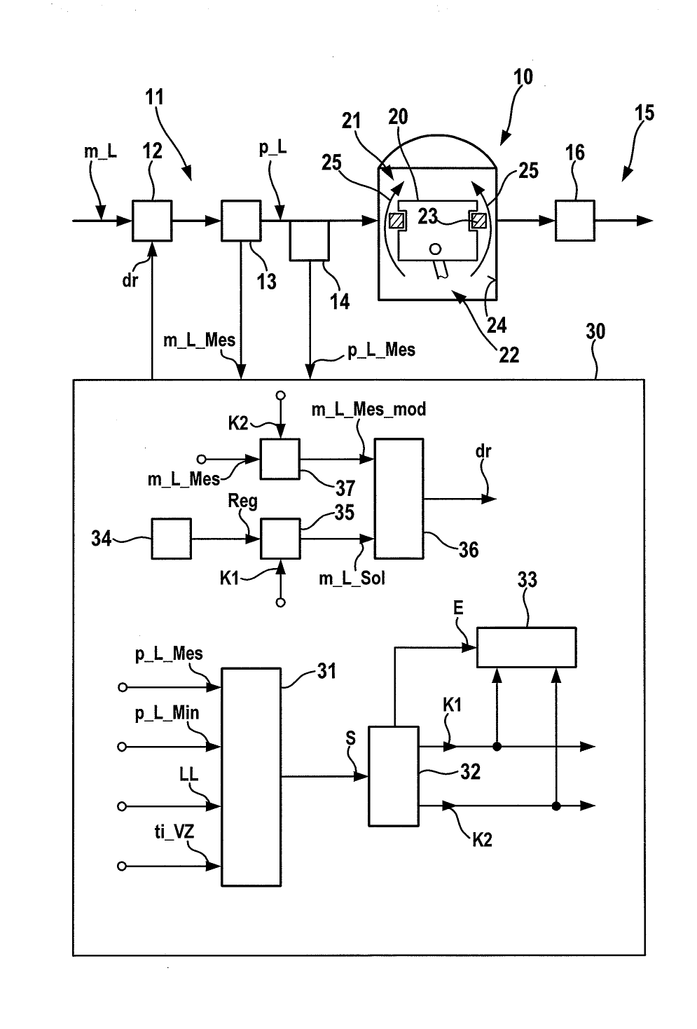

This application claims benefit of Serial No. 10 2008 054 719.0, filed 16 Dec. 2008 in Germany and which application is incorporated herein by reference. To the extent appropriate, a claim of priority is made to the above disclosed applications.

### TECHNICAL FIELD

The invention is based on a procedure for regenerating a particle filter that is arranged in a combustion engine and on a device.

Subject matter of the present invention are also a computer program and a computer program product.

### BACKGROUND

DE 10 2006 010 085 A1 describes a procedure, at which the combusted air that has been sucked in by a self-igniting combustion engine is advanced over a throttle valve. The throttle valve as well as an exhaust gas recirculation is controlled during the regeneration of a particle filter that is arranged in the exhaust gas area of a combustion engine in a pre-defined order so that an overheating of the particle filter is avoided.

DE 102 34 092 A1 describes a procedure, at which the oxygen feed takes place at a particle filter that is arranged in an exhaust gas area of a combustion engine, which is just regenerated, depending on an exhaust gas lambda, which is measured in the exhaust gas area and which can be influenced amongst others with a throttle valve.

The invention is based on the task to provide a procedure for regenerating a particle filter that is arranged in the exhaust gas area of a combustion engine as well as a device for implementing the procedure, which in particular ensure a reliable operation of the combustion engine.

### SUMMARY

The procedure according to the invention for regenerating a particle filter that is arranged in the exhaust gas area of a combustion engine, whereby at least one temporal throttling of the intake air as well as a detection of the intake pressure is provided during the regeneration, is thereby characterized, in that the intake air pressure is compared to a lower intake air pressure threshold value and when falling below the intake air pressure threshold value the throttling of the intake air is reduced.

For regenerating the particle filter a minimum temperature is required in the particle filter so that the stored particles can oxidize. A measure for increasing for example the exhaust gas temperature provides the throttling of the air that has been taken in by the combustion engine, in order to reduce the exhaust gas mass current. By this throttling of the air that has been taken in by the combustion engine a negative pressure related to the atmosphere pressure can occur in the combustion chambers of the cylinders of the combustion engine. A negative pressure can cause that oil is sucked in from the crankcase of the combustion engine into the combustion chamber passing the piston rings of the cylinders.

The sucking in of the oil should be avoided so that no additional combustible material gets into the combustion chamber, which is not detected metrological. The oil can be ignited in addition to the fuel, whereby the explosion pressure can increase uncontrolled compared to an expected and specified value. Besides, there are more reasons for avoiding oil to be sucked in, for example to keep the oil consumption above the time within limits.

The sucking in of the oil occurs depending on the negative pressure in the combustion engine. Principally the intake air pressure can be calculated at a familiar throttle valve position in connection with a air mass or air volume current that is detected by an intake air sensor and therefore be limited without further additional measures by an increase of the throttle valve opening to a maximally proper lower value. In practice though, it has to be reckoned with an error of the intake air sensor signal that is provided by the intake air sensor in particular due to a drift of the intake air sensor.

At this point the procedure according to the invention begins thereby that the danger of the oil suction due to the negative pressure in the combustion chamber of the individual cylinders of the combustion engine is limited during the regeneration of the particle filter precautionary to a lower maximum amount. Because the oil suction cannot be directly detected metrological without further ado the procedure according to the invention provides the limitation of the intake air pressure to a default lower negative pressure threshold value, which can be determined experimentally in the range of an application by the producer of the combustion engine. When falling short of the negative pressure threshold value the throttling of the intake air is reduced, whereby the negative pressure is reduced.

A first embodiment provides that the comparison of the intake air pressure with the intake air pressure threshold value is carried out during an at least quasi-stationary operating state of the combustion engine. As quasi-stationary operating status of the combustion engine the idle state of the combustion engine qualifies in particular, which can be identified without a problem due to the engine speed or the load state.

A further improvement of the embodiment provides that the comparison of the intake air pressure with the intake air pressure threshold value is not carried out until a delay time has elapsed, after the combustion engine has reached the quasi-stationary operating state, in particular the idle state.

Another embodiment provides that when falling below the lower intake air pressure threshold value an increase of an intake air nominal value is initiated with a first correction signal.

Alternatively or additionally it can be provided that when falling short of the lower intake air pressure threshold value a sensor signal editing of an intake air sensor signal that is supplied by an intake air sensor is intervened with a second correction signal.

The intervention by the first and/or second correction signal increases the throttle valve opening, so that the negative pressure in the intake area of the combustion engine downstream after the throttle valve is reduced.

Another embodiment of the procedure according to the invention provides that the number of the cases when falling short of the lower intake air pressure threshold value is counted and that the counting result is stored on a storage. The storage can be read during the maintenance of the combustion engine. Thereby it can be determined that a critical state has already occurred several times, during which the danger of the oil suction would have occurred.

Additionally or alternatively it can be provided that the first and/or second correction signal is compared to correction signal threshold values and that when exceeding the correction signal threshold values an error message is stored in the storage. With this measure during the maintenance of the combustion engine it can also be determined with the aid of reading the storage content that a significant correction was required, which lies outside the specification, so that an exchange of the intake air sensor can take place due to an improper drift.

The device according to the invention for regenerating a particle filter that is arranged in the exhaust gas area of a combustion engine, whereby a throttling of the intake air as well as a detection of the intake air pressure is provided, concerns initially a customized control unit, which comprises means for implementing the procedure.

An intake air negative pressure evaluation is in particular provided as one measure, which compares the intake air pressure with the lower intake air pressure threshold and provides a switch signal depending on the result of the comparison, which can be used for increasing the throttle valve opening, in order to reduce the negative pressure.

The control unit comprises preferably at least one electric storage, which stores the steps of the procedure as control unit program.

The computer program according to the invention provides that all steps of the procedure according to the invention are carried out if it runs on a computer.

The computer program product according to the invention with a program code that is stored on a machine-readable device carries out the procedure according to the invention, if the program runs on a computer.

Embodiments of the invention are illustrated in the drawing and further explained in the following description.

### BRIEF DESCRIPTION OF THE DRAWING

The FIGURE shows a technical environment, in which a procedure according to the invention is carried out.

### DETAILED DESCRIPTION

The FIGURE shows a combustion engine 10, in whose intake air area 11 a throttle valve 12, an intake air sensor 13 and an intake air pressure sensor 14 are arranged. A particle filter 16 is arranged in the exhaust gas area 15 of the combustion engine 10. The combustion engine 10 comprises at least one cylinder, in which a piston 20 is arranged movable, which separates a combustion chamber 21 from a crankcase 22. In order to seal up the combustion chamber 21 from the crankcase 22 a piston ring 23 is provided, which slides during the operation of the piston 20 at a cylinder interior wall 24. Despite the piston ring 23 an oil suction 25 can occur from the crankcase 22 to the combustion chamber 22 between the piston ring 23 and the cylinder interior wall 24.

In the intake area 11 an intake air m_L appears, which provides an intake air pressure p_L downstream after the throttle valve 12. The intake air sensor 13 supplies a control unit 30 with a measure for the sucked-in air mass or air volume as intake air sensor signal m_L_Mes and the intake air pressure sensor 14 a measure for the intake air pressure p_L downstream after the throttle valve 12 as intake air pressure sensor signal p_L_Mes. The control unit 30 provides the throttle valve 12 with a throttle valve signal dr.

The control unit 30 contains an intake air negative pressure evaluation 31, which is provided with the intake air pressure sensor signal—PL_Mes, a lower intake air pressure threshold value p_L_Min, an idle signal LL and a delay time ti_VZ. The intake air negative pressure evaluation 31 provides a switch signal S to a correction signal determination 32, which provides an event signal E to a storage 33 and which provides a first and a second correction signal K1, K2.

The control unit 30 contains furthermore a particle filter regeneration control unit 34, which provides a regeneration demand signal Reg to an intake air nominal determination 35, which provides an intake air nominal value m_L_Sol to a throttle valve control unit 36. The throttle valve control unit 36 is furthermore supplied with a modified intake air sensor signal m_L_Mes_mod, which provides a sensor signal editing 37 depending on the intake air sensor signal m_L_Mes. The first correction signal K1 is provided to the intake air nominal value determination 35 and the second correction signal K2 to the sensor signal editing 37.

The procedure according to the invention works as follows:

In normal operation of the combustion engine 10 the intake air m_L is combusted together with the provided fuel in the combustion chamber 21 of the combustion engine 10. During the combustion particles can appear, which are collected in the particle filter 16. An influencing of the exhaust gas lambda is enabled by an influencing of the fuel amount that is supplied to the combustion engine 10 as well as by a throttling of the intake air m_L with the aid of the throttle valve 12 together with a not further shown lambda sensor that is arranged in the exhaust gas area 15.

The particle filter regeneration control unit 34 determines the load status of the particle filter 16 with stored particles. The particle filter regeneration control unit 34 can calculate the load status of the particle filter 16 for example from at least one parameter of the combustion engine 10 such as for example the fuel amount that has been supplied to the combustion engine 10 and the intake air m_L as well as further parameters such as the engine speed of the combustion engine. Alternatively or additionally the load status of the particle filter 16 can be determined by a determination of the difference pressure that occurs at the particle filter 16 in connection with the exhaust gas volume current.

If a default load status of the particle filter 16 is reached, the particle filter regeneration control unit 34 provides the regeneration demand signal Reg. the regeneration demand signal Reg initiates processes, which cause during the regeneration at least temporarily an increase of the exhaust gas temperature and/or at least partially a change of the composition of the exhaust gas, whereby for example a catalytically supported oxidization reaction in the exhaust gas area 15, for example upstream before the particle filter 16 and/or within the particle filter 16 can occur, whereby the particle filter 16 is warmed up, in order to reach the ignition temperature of the stored particles.

A measure for increasing the exhaust gas temperature is to throttle the intake air m_L with the aid of the throttle valve 12 during the regeneration of the particle filter 16 at least temporarily. Therefore the regeneration demand signal Reg is provided to the intake air nominal value determination 35, whereby the throttle valve opening can be reduced, so that the negative pressure sinks.

The throttling of the intake air m_L is detected by the intake air sensor 13, which provides the intake air sensor signal m_L_Mes to the sensor signal editing 37, which for example contains measures for correcting the sensor characteristic line. The modified intake air sensor signal m_L_Mes_mod is compared in the throttle valve control unit 36 to the intake air nominal value m_L_Sol. Depending on the comparison the throttle valve signal dr is determined preferably within the range of a regulation and the throttle valve 12 is correspondingly controlled.

Due to a negative pressure occurring in the intake area 11 downstream after the throttle valve 12 related to the atmosphere pressure of the intake air m_L, which also occurs in the combustion chamber 21 of the combustion engine 10, especially at low load statutes, an oil intake 25 can occur from the crankcase 22 to the combustion chamber 21 along the cylinder interior wall 24 pass the piston rings 23.

The oil intake 25 should be avoided so that for example no additionally combustible material gets into the combustion chamber 21, which is not detected metrological. The oil intake 25 occurs depending on the negative pressure. Principally the intake air pressure p_L can be calculated at a familiar throttle valve signal dr in connection with the intake air sensor signal m_L_Mes and therefore be limited without further measures with the aid of the throttle valve signal dr to a maximally allowed lower value. In the field though, it has to be reckoned with an error of the intake air sensor signal m_L_Mes that is provided by the intake air sensor 13 in particular due to a drift of the intake air sensor 13. Such a measuring error or a drift do usually not matter in the normal operation of the combustion engine 10, because the not further described lambda regulation can consider and regulate the error. If the intake air pressure p_L is nevertheless evaluated and used as the only parameter without the possibility of an correction, the sensor error, for example a signal drift, cannot be recognized and balanced.

Therefore the intake air negative pressure evaluation 31 is provided, which can avoid the oil intake 25 thereby that the intake air pressure p_L that occurs in the intake area 11 downstream after the throttle valve 12 is compared to the lower intake air pressure threshold value p_L_Min and that in the case that the threshold value is fallen short of the switch signal S is provided, whereby the switch signal S can be directly used according to a simple embodiment for increasing the opening of the throttle valve 12. The switching signal S could therefore be directly provided to the throttle valve control unit 36, which influences the throttle valve signal dr correspondingly. In the shown embodiment the switching signal S is provided to the correction signal determination 32, which provides not only the event signal E but also the first and/or second correction signal K1, K2.

The event signal E is counted, whereby the counted result is stored in the storage 33 for a later evaluation. Due to the number of the events a decision for a possibly required exchange of the intake air sensor 13 can be made.

The at least one correction signal K1, K2 can also be directly provided to the throttle valve control unit 36 for influencing the throttle valve signal dr.

According to an advantageous embodiment the intake air nominal value m_L_Sol in the intake air nominal value determination 35 is influenced with the first correction signal K1 in such a way that the intake air nominal value m_L_Sol is increased, so that the negative pressure of the intake air m_L is reduced as a consequence.

Alternatively or additionally the second correction signal K2 can be provided according to another advantageous embodiment and be used to reduce the intake air pressure sensor signal p_L_Mes that is provided by the intake air pressure sensor 14 in the sensor signal editing 37, in order to announce a higher negative pressure, whereby the throttle valve 12 is further opened as a consequence in order to reduce the negative pressure of the intake air m_L.

The increase of the air m_L that is sucked in by the combustion engine and dependant on the measure that is provided by the invention, can be compensated in the range of the not further described lambda regulation by additional metering of fuel for maintaining a default lambda nominal value.

1. A procedure for regenerating a particle filter that is arranged in the exhaust gas area of a combustion engine, whereby at least temporarily a throttling of the intake air (m_L) as well as a detection of the intake air pressure (p_L) is provided during the regeneration, is thereby characterized, in that the intake air pressure (p_L) is compared to a lower intake air pressure threshold value (p_L_Min) and when falling below the intake air pressure threshold value (p_L_Min) the throttling of the intake air (m_L) is reduced.

2. The procedure according to claim 1, wherein the comparison of the intake air pressure (p_L) with the intake air pressure threshold value (p_L_Min) is carried out during the idle state (LL) of the combustion engine.

3. The procedure according to claim 1, wherein the comparison of the intake air pressure (p_L) with the intake air pressure threshold value (p_L_Min) is not carried until the elapsing of a delay time (ti_VZ), after the combustion engine has reached the idle state (LL).

4. The procedure according to claim 1, wherein an increase of an intake air nominal value (m_L_Sol) is initiated with a first correction signal (K1) when the lower intake air pressure threshold value (p_L_Min) is fallen short of.

5. The procedure according to claim 1, wherein it is intervened with a second correction signal (K2) into a sensor signal editing for the intake air pressure sensor signal (p_L_Mes) that is supplied by an intake air sensor when the lower intake air pressure threshold value (p_L_Min) is fallen short of.

6. The procedure according to 1, wherein the amount of cases when the lower intake air pressure threshold value (p_L_Min) is fallen short of is counted with the aid of an event signal (E) and in that the counting result is stored in a storage.

7. The procedure according to claim 4, wherein the first and/or the second correcting signal (K1, K2) are compared to correction signal threshold values and that when exceeding the correction signal threshold values an error message is stored in a storage.

8. A device for regenerating a particle filter that is arranged in the exhaust gas area of a combustion engine, whereby at least temporarily a throttling of the intake air (m_L) as well as a detection of the intake air pressure (p_L) is provided during the regeneration, is thereby characterized, in that at least one customized control unit (30) is provided for implementing the procedure according to claim 1, which comprises means for implementing the procedure.

9. A computer program, which carries out all steps of a procedure according to claim 1, if the program runs in a control unit.

10. A computer program product with a program code that is saved on a machine-readable device for implementing the procedure according to claim 1, if the program is carried out in a control unit.
